(19) United States
(12) Patent Application Publication
(10) Pub. No.: US 2011/0192926 A1
(43) Pub. Date: Aug. 11, 2011

(54) Comminution Machine And Method For Producing A Hollow Rotor For Said Machine

(75) Inventor: Peter Roessler, Ilsfeld (DE)

(73) Assignee: WEIMA MASCHINENBAU GMBH, Ilsfeld (DE)

(21) Appl. No.: 13/060,209

(22) PCT Filed: Aug. 21, 2009
(86) PCT No.: PCT/EP09/06086

§ 371 Date: Mar. 31, 2011

(30) Foreign Application Priority Data
Aug. 22, 2008 (DE) 10 2008 039 258.8

(51) Int. Cl. B02C 18/16; B23P 19/00

(52) U.S. Cl. 241/189.1; 29/428

(57) ABSTRACT

A comminution machine comprises a rotor which is equipped with blade elements and interacts with at least one counter-blade that is mounted stationarily in the housing. The rotor is separated by a sieve from a collection compartment for comminuted material. The rotor has a rotor base having through-openings, in which rotor base a screw is arranged. In this way, the rotor itself can be used as an additional sieve via which sufficiently comminuted material can be discharged.

### RELATED APPLICATIONS

This application claims the filing benefit of International Patent Application No. PCT/EP2009/006086, filed Aug. 21, 2009, which claims the filing benefit of German Patent Application No. 10 2008 039 258.8 filed Aug. 22, 2008, the contents of which are incorporated herein by reference.

### TECHNICAL FIELD

The invention relates to a comminution machine according to the precharacterising clause of claim 1 and a process for manufacturing a hollow rotor for use in a comminution machine of this type.

### BACKGROUND OF THE INVENTION

A comminution machine of the type mentioned above is described in DE 20 2006 018 524 U1.

In this known comminution machine, sufficiently comminuted material passes through the holes of a partially cylindrical sieve which surrounds the rotor. Through this sieve, the comminuted material then arrives in a collecting chamber in which a conveying screw rotates.

Owing to the webs in the sieve, material which in itself is also sufficiently comminuted is unable to pass through the sieve as it first moves over the sieve. Instead, some of the comminuted material located on the outside of the rotor as a result of the blade bodies of the rotor is moved upwards again and back into the cutting gap between the blade bodies and counter blade, where a second, in itself unnecessary, comminution takes place. As a result of material pieces which are themselves sufficiently comminuted being carried further, the friction under which the rotor operates is increased since these material pieces have a very large contact surface in relation to their volume, whereas even large material pieces do not contact the rotor with much greater intensity. Also, the sufficiently comminuted material pieces can become jammed between the lateral surface of the rotor and the webs of the sieve surrounding this latter.

The present invention is directed to resolving these and other matters.

### SUMMARY OF THE INVENTION

By means of the present invention, an object is therefore to develop a comminution machine according to the precharacterising clause of the claim such that the removal of sufficiently comminuted material from the comminution region is improved.

This object may be achieved according to the invention by a comminution machine having a rotor which carries blade bodies and has a counter-blade arrangement which is fixed to the frame and cooperates with the blade bodies of the rotor, having a sieve by way of which the rotor is separated from a collecting chamber for comminuted material pieces, and having a drive motor which acts on the rotor, wherein the rotor is hollow and is provided with a plurality of through-openings in its circumferential wall and in that at least one end portion of the rotor has a discharge opening.

In the comminution machine according to the invention, the rotor itself is provided with passages and thus, for its part, forms a cylindrical sieve through the inside of which sufficiently comminuted material pieces can be removed. These material pieces can pass through the passages as the rotor rotates and then be moved inside the rotor by gravity or conveying means to a discharge end of the rotor.

The portions of comminuted material pieces removed by the rotor and the material pieces falling through the sieve surrounding the rotor can then be combined into a single stream of comminuted material pieces and stored in conventional manner or processed further, e.g. by briquetting, carbonising at low temperatures or combustion.

Advantageous further developments of the invention are indicated in subclaims.

In a further development of the invention it is advantageous in that pockets, which have to be provided in any case for mounting the blade bodies or blade carriers carrying the blade bodies, can at the same time serve as passages by way of which sufficiently comminuted material pieces can be removed to the inside of the rotor.

In a comminution machine according to a further development of the invention, the passages provided in the rotor move at least partially on the same trajectories as the blade bodies. With regard to receiving the material pieces cut off by the blade bodies, this is particularly advantageous.

In a comminution machine according to yet a further development of the invention, the passages for removing the comminuted material pieces are located directly in front of a blade body, which thus moves small material pieces as they are gathered together into the vicinity of the passages and directs them into said passages.

In a comminution machine according to a further development of the invention, the chips which are detached from comminution material by a blade body pass directly into the passages of the rotor since their orientation in relation to the blade body and therefore in relation to the passage located near to this latter is not able to alter substantially after the cutting off procedure.

A further development of the invention also enables small material particles of this type, which have been moved away from the path of the blade bodies owing to movements with other material pieces, to be removed by the rotor.

Another further development of the invention enables reliable removal of small material pieces which have entered inside the rotor, even with a horizontal alignment of the rotor axis which is preferred in terms of uniformly supplying comminution material to the rotor by gravity.

In a comminution machine according to a further development of the invention, there is no need for a separate drive for moving the conveying coil.

In a comminution machine according to yet a further development of the invention, it is possible to specify a relative speed between the conveying coil and the rotor body, which is advantageous in terms of reliably removing even damp volumes of material pieces which tend to adhere together.

A further development of the invention is advantageous in terms of a simple, unimpeded removal of the comminuted material pieces from inside the rotor.

With this, it is also possible according to claim 11 to subject the rotor to high loads in its regions adjacent to the open end.

A rotor according to a further development of the invention can be simply mounted at both ends by means of stub shafts and the comminuted material pieces removed via the inside of the rotor and the material piece removed via the sieve surrounding the rotor can be brought together inside a common housing.

With this, it is ensured in the comminution machine according to the invention that comminution material which has not been comminuted cannot get stuck in the discharge openings.

The further development of the invention is advantageous in terms of maintaining little friction between large bodies located in a supply chamber of the comminution machine and the lateral surface of the rotor.

In a comminution machine of the invention, all comminuted material pieces which fulfil the criteria specified by the sieve surrounding the rotor are removed under the same sieving action, either via the rotor which at the same time acts as a sieve or via the sieve surrounding the rotor.

A process according to the invention is advantageous in that it is possible to start with an economical standard starting material, namely thick sheet metal plates, such as those frequently used in plant construction and machine construction. Typical thicknesses of sheet metal plates of this type can be in the range of 5 to 40 mm, preferably between 10 and 30 mm.

It is also possible to easily manufacture circumferential walls for rotors with different diameters from this standard starting material, whereas corresponding tubing is a custom-made product which is expensive and often has lengthy delivery times.

In the process according to the invention, it is also possible to carry out process steps very simply on the planar blank which can only be performed with difficulty on a cylindrical circumferential wall of a rotor, in particular the provision of through-openings as described in a further development of the invention. These can simply be cut into the planar plate using an NC cutting-off machine (laser cutting and welding machine or the like).

With the further development of the invention, it is achieved that the outer face of the circumferential wall receives a precise cylindrical form which is difficult to accomplish by bending alone. A circumferential wall which is manufactured according to the invention is thus notable for low manufacturing costs, ready availability and the precise cylindrical form of its outer face and is thus very similar to a circumferential wall which has been manufactured from tubing.

With the further development of the invention, it is achieved that the comminution rotor produced with the circumferential wall operates smoothly on a comminution machine.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

FIG. 1 a central section, transverse to the rotor axis, through a comminution machine;

FIG. 2 a lateral view of the comminution machine according to FIG. 1, seen here from the left;

FIG. 3 a perspective view of the hollow rotor of the comminution machine according to FIGS. 1 and 2;

FIG. 4 an axial section through the rotor according to FIG. 3;

FIG. 5 a plan view of the rotor according to FIGS. 3 and 4;

FIG. 6 a transversal central section through the rotor according to FIGS. 3 to 5 along the section line VI-VI of FIG. 5;

FIG. 7 a view similar to FIG. 3, but in which a modified rotor is shown with an internal conveying coil;

FIG. 8 an axial section through the rotor according to FIG. 7;

FIG. 9 a view similar to FIG. 8, but in which a modified rotor is shown with ribs seated thereon;

FIG. 10 a view similar to FIG. 4, in which a modified rotor mounted at both ends by way of stub shafts is shown;

FIG. 11 a plan view of a rectangular blank of thick sheet metal, which is provided with a pattern of through-openings on an NC laser cutting and welding system; and,

FIG. 12 a perspective view of a cylindrical circumferential wall for a comminution rotor, which is produced from the planar blank according to FIG. 10 by bending, welding and skimming.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

The comminution machine shown in the drawing has a housing (denoted as a whole by 10) which is welded together from thick, suitably canted steel plate parts.

Mounted on side walls 12 of the housing, by way of bearings which are not shown, there is a comminution roller 14 (denoted as a whole by 14) which is also described as a rotor. This carries individual blade bodies 16, 18 which are offset from one another in the circumferential direction and the axial direction and which cooperate with fixed counter blades 19, 20 with complementary serrations.

For improved clarity, the comminution roller 14 is only shown equipped with one or two blade bodies. It goes without saying that blade bodies should be visualised analogously at the other mounting points.

A side wall 22, which is situated on the left in the drawing, supports a guide wall 24 which slopes obliquely downwards.

A feed slide 28, which is constructed as a hollow box-type part and by means of which a double-acting operating cylinder 30 may be moved back and forth, is displaceable over a base wall 26. Its upper side cooperates with a protective wall 32 which is connected to a wall 34 of the housing which is situated on the right in the drawing. The side walls of the feed slide 28 run in front of the side walls 12 with a slight play.

An end wall 36 of the housing 10, which adjoins the upper end of the wall 34, forms the last part of the enclosure of a supply chamber 38 in which the material to be comminuted is provided.

Arranged between the counter blades 19, 20, there is a partially cylindrical perforated sieve 39 which is located outside the path (denoted by a broken line n) of the points of the blade bodies 16, 18. Obliquely sloping lower funnel walls guide the cuttings falling through the perforated sieve 39 downwards to a collecting channel 40 in which a conveying screw 42 operates. A screw drive 44 is associated with this conveying screw.

To rotate the comminution roller 14, a synchronous motor 46 is provided which acts on the comminution roller 14 by way of a step-down gear 48 and a detachable coupling 50.

The speed of the synchronous motor 46 may be controlled by the frequency of the supply voltage supplied thereto. A frequency converter 52, which is connected to the public 50 Hz network by way of a power line 54, serves to supply the synchronous motor.

A control line 56 connects the frequency converter 52 to a control unit 58 of the comminution machine.

By way of the control line 56, the frequency converter 52 receives a set value for the output frequency to be adjusted.

A current sensor 60 determines the current flowing in the supply line of the synchronous motor 46. With the aid of the output signal of the current sensor 60, the control circuit 56 can recognise the load under which the comminution roller 14 is operating.

If the current measured by the current sensor 60 exceeds a predetermined maximum permissible value, the control line 56 stops the synchronous motor 44 and then drives it for a predetermined time span in the reverse direction. Thus, hard parts in the comminution material which have wedged between the blade bodies 16, 18 and the counter blades 19, 20 are loosened again and generally orientated elsewhere so that, when a movement of the comminution roller 14 is then initiated again in the right direction (indicated in the drawing by an arrow), other cutting conditions are achieved in the cutting gaps formed by the blade bodies 16, 18 and the counter blades 19, 20 and the hard parts in the comminution material can then be broken or cut.

If the control unit 58 establishes that the comminution capacity generated by the comminution roller 14 is below a predetermined set value, it drives an operating cylinder 62 in such a way that this presses comminution material which has dropped down from the supply chamber 32 against the comminution roller 14.

As a result of the fact that the synchronous motor 46 acts on the comminution roller 14 by way of the step-down gear 48, the comminution roller can be subjected to a very high torque and it can also comminute very hard material between the blade bodies 16, 18 and the counter blades 19, 20 although the synchronous motor 44 does not require an extremely high connected load. In practice, the synchronous motor 44 can have a connected load in the range in the order of 100 kW, as is generally readily available at industrial operating sites.

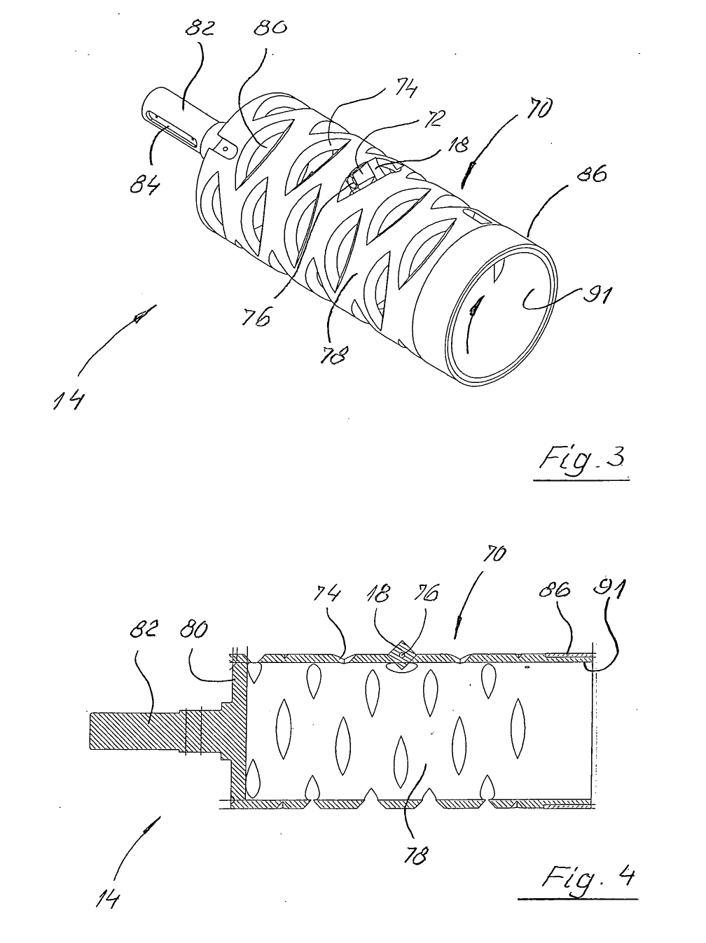

As shown in FIG. 3, the rotor 14 has a hollow cylindrical rotor body 70 which carries the blades 16, 18 by way of a welded-on blade carrier 72.

The rotor body 70 is provided with milled V-shaped pockets 74 whereof the lateral peripheries form an angle of 90°. This angle is therefore matched to the lateral faces, set at less than 90°, of the square blade carriers 72. The latter are fixedly connected to the lateral faces of the pockets 74 by weld seams.

The blades 18 likewise have a square edge contour and are detachably connected to the associated blade carriers by way of a central fixing screw 76. The edge length of the blades 18 is some (several mm) greater than that of the blade carriers 72 so that they project radially over the latter.

The rotor body 70 has a substantially cylindrical circumferential wall 78 and a left-hand end wall 80 which supports a stub shaft 82. The latter is mounted on bearings (not shown in more detail) of the housing 10 and may be connected to the hollow shaft of the synchronous motor 46 by way of a keyway 84.

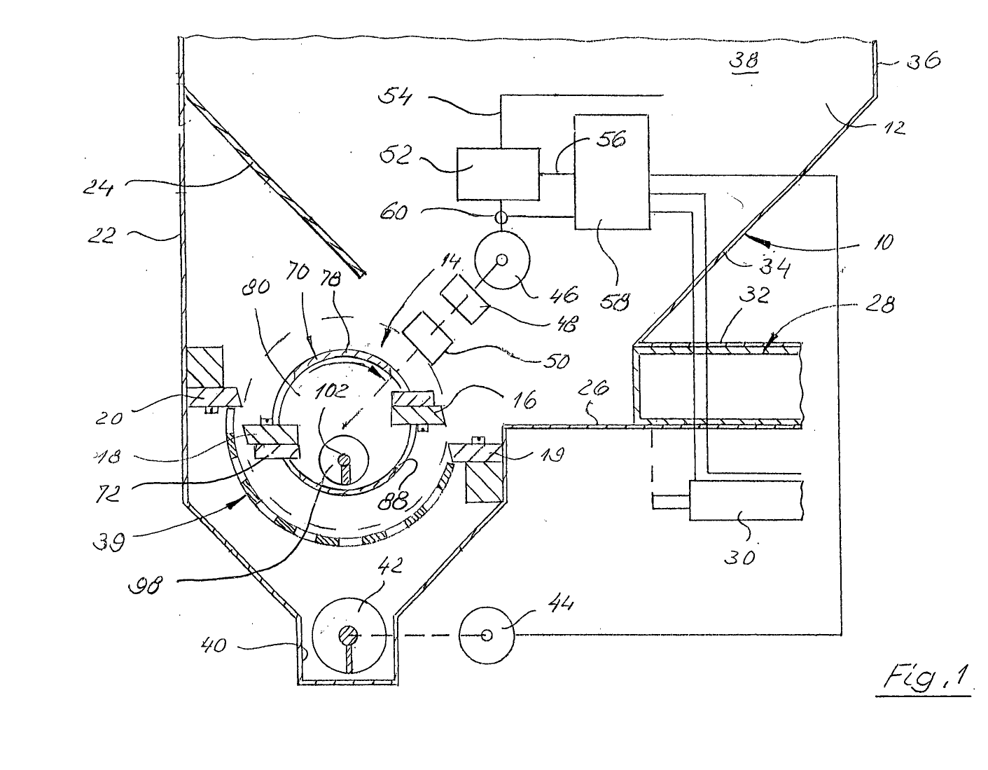

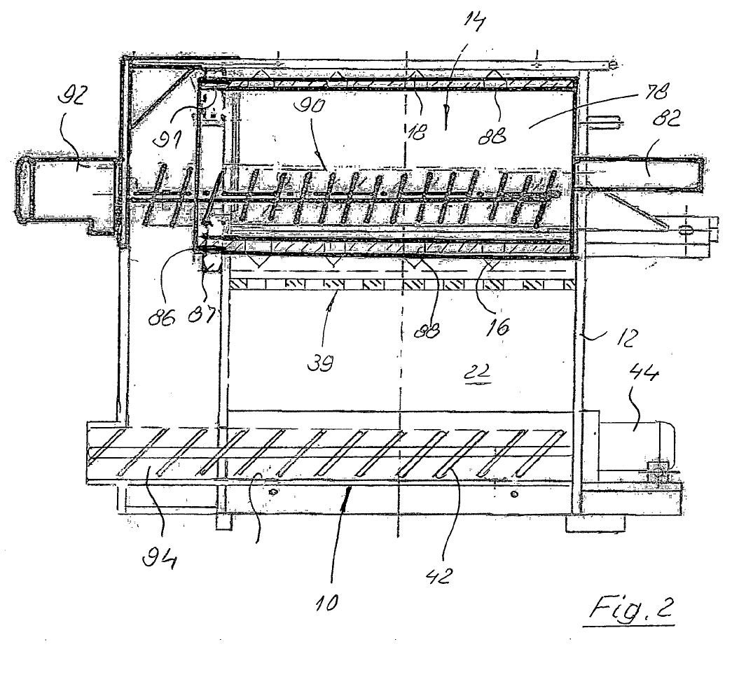

As can be seen from the drawing, the pockets 74 do not extend over an end region (situated on the right in FIG. 1) of the rotor body 70, the axial dimensions of which end region amount to approximately ⅕ of the overall axial dimensions of the circumferential wall 78. Located on this axial end portion of the rotor body 70, there is a bearing ring 86 which cooperates with four bearing rollers (indicated by 87 in FIG. 2) which is supported offset through 90° from one another by the adjacent end wall of the housing 10. The rotor 14 is thus mounted on both sides.

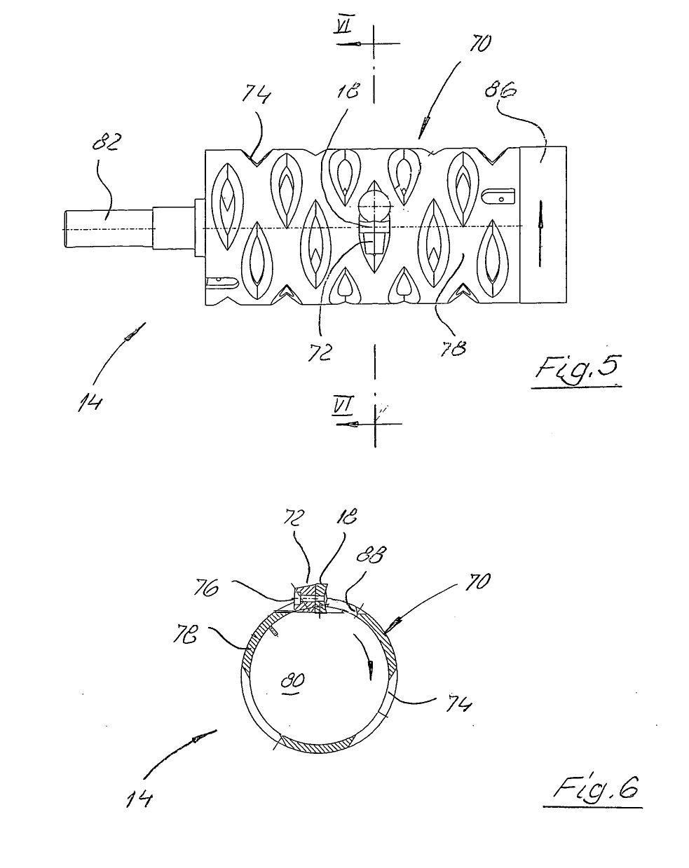

As can be seen in particular in FIG. 6, the front sides of the blade bodies 16, 18 have a concavely dome-shaped form to produce four points located at the corners of the square, of which three are covered in each case and one projects outwards over the circumference of the rotor body 70. It is thus possible to change the blade 18 four times and have a new point each time.

As can be seen from the drawing, the depth of the V-shaped pockets 74 is greater than the wall thickness of the circumferential wall 78 so that the interior space of the rotor body 70 is truncated by the base of the pockets 74.

In the drawing, the direction of rotation of the rotor 14 is indicated in each case by an arrow. If the blade 18 is now mounted so that its central plane is located substantially in a plane intersecting the axis of the rotor 14, a relatively large through-opening 88 is produced in front of the respective blade 18 (as is clearly visible in FIGS. 1 and 6), by way of which opening the outside of the rotor 14 communicates with its inside.

If, in the comminution machine described above, material which is in itself sufficiently comminuted collects above the rotor 14, it is carried along by the blades 18 and can then pass through the through-opening 88 into the interior of the rotor 14, whether by gravity or as a result of subsequent pressure from a material load.

As can be seen in FIG. 2, a conveying screw 90, which is rotated by a motor 92, is provided inside the rotor 14. The conveying screw 90 is located in the lowest region of the rotor interior and moves comminuted material found there in the axial direction (to the left in FIG. 2 and to the right in the other Figures).

The open end (situated on the left in FIG. 2) of the rotor body 70 provides an axial discharge opening 91. Comminuted material which has arrived inside the rotor is removed by way of this opening.

This material then falls downwards at the open end of the rotor body 70 and arrives in a collecting chamber 94 which is positioned as an extension of the collecting channel 40 so that the material falling downwards is discharged by the conveying screw 40 similarly to that material which has fallen through the sieve 39 surrounding the rotor 14.

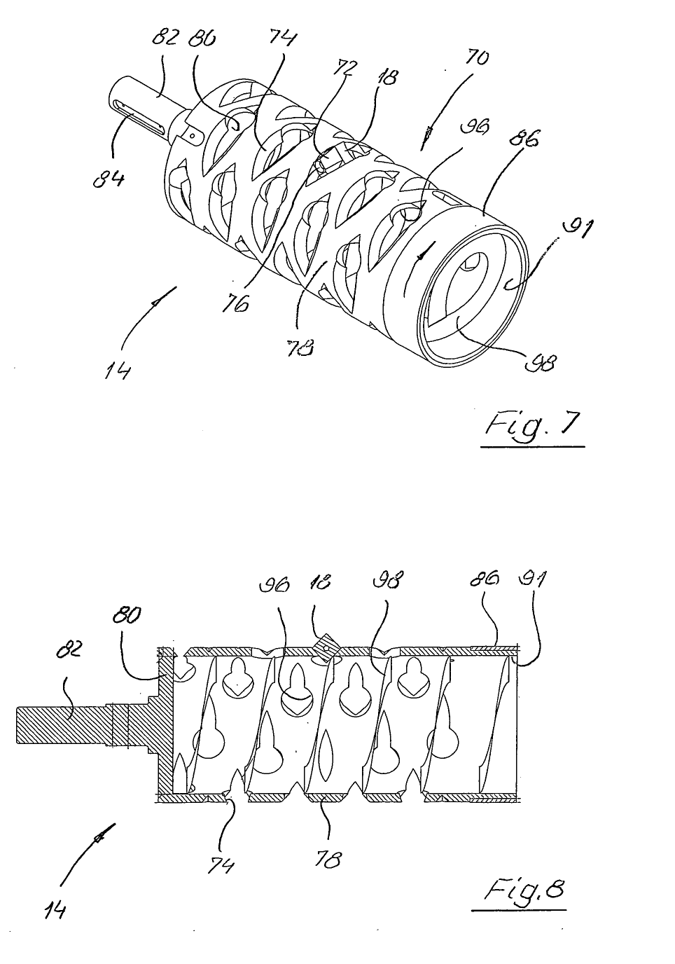

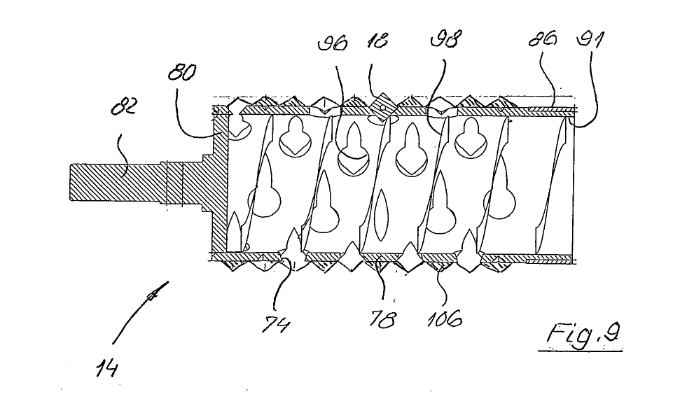

The exemplary embodiment according to FIGS. 7 and 8 differs from that according to FIGS. 3 and 6 in that, in each of the pockets 74 in that region which is located in front of the respective blade 18 (as seen in the direction of rotation), a circular through-opening 96 is provided which is therefore similar in terms of its geometry to the circular holes in the sieve 39. This design of the through-opening 96 enables the passage of comminuted material pieces in the same way as in the sieve 39.

A further difference of the exemplary embodiment according to FIGS. 7 and 8 consists in that a helical conveying rib 98 is arranged (e.g. fixed by tack welds) in simultaneously rotating manner on the inside of the circumferential wall 78. This conveying rib conveys small material pieces located at the bottom of the inside of the circumferential wall 78 in the axial direction to the open end of the rotor body 70. It thus replaces the conveying screw 90 moved by a separate motor 92, which can be sufficient for dry material pieces.

FIG. 9 differs from the exemplary embodiment according to FIGS. 7 and 8 in that, seated on the outer face of the rotor body 70, there are axially abutting ribs 106 whereof the flanks have an opening angle of 90 degrees and are flush with the path of the blade bodies in the circumferential direction and which are located slightly (e.g. 1 to 3 mm) behind the edges of the blade bodies 16, 18 in the radial direction. The pockets 74 are thus milled into the ribs 106 so that their lowest line is opposite the highest line of the ribs in question.

The ribs 106 prevent large pieces to be comminuted from lying with a large area against the lateral surface of the rotor body 70.

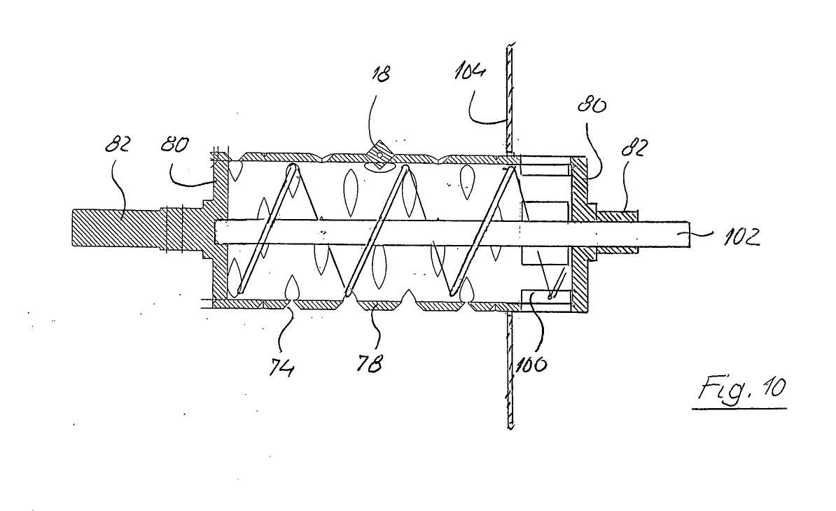

The exemplary embodiment according to FIG. 10 differs from those described above in that the rotor body 70 has an end wall 80 at both ends, which supports a respective stub shaft 82.

To discharge comminuted material, large windows 100 to which the conveying screw 90 conveys loose material located inside the rotor body 70 are provided in the right-hand end region (situated on the right in the drawing) of the rotor body 70, which does not carry any blades 18. At the windows 100, this material then falls downwards and likewise passes again into an extension of the collecting channel 40 shown in FIG. 1, in a manner similar to that of the exemplary embodiment according to FIG. 2.

In order to stop the conveying screw 90, which is now occupying the internal diameter of the rotor body 70 with a radial play of several mm (e.g. 3 mm), or to move it by means of a separate drive, the stub shaft 82 situated to the right in FIG. 9 is constructed as a hollow shaft and a shaft 102 leads through its interior, which shaft 100 supports the conveying screw 90 and is mounted in the right-hand hollow stub shaft 82 and a blind bore in the left-hand end wall 80.

The discharge region of the rotor 14 is separated from the supply chamber 38 by an intermediate wall 104 so that the windows 100 cannot become blocked by large material pieces.

It can be seen that, in the comminution machines described above, two sieve devices are provided: on the one hand a partially cylindrical perforated sieve 39 which surrounds the rotor 14 on the outside, on the other the circumferential wall of the rotor 14 itself.

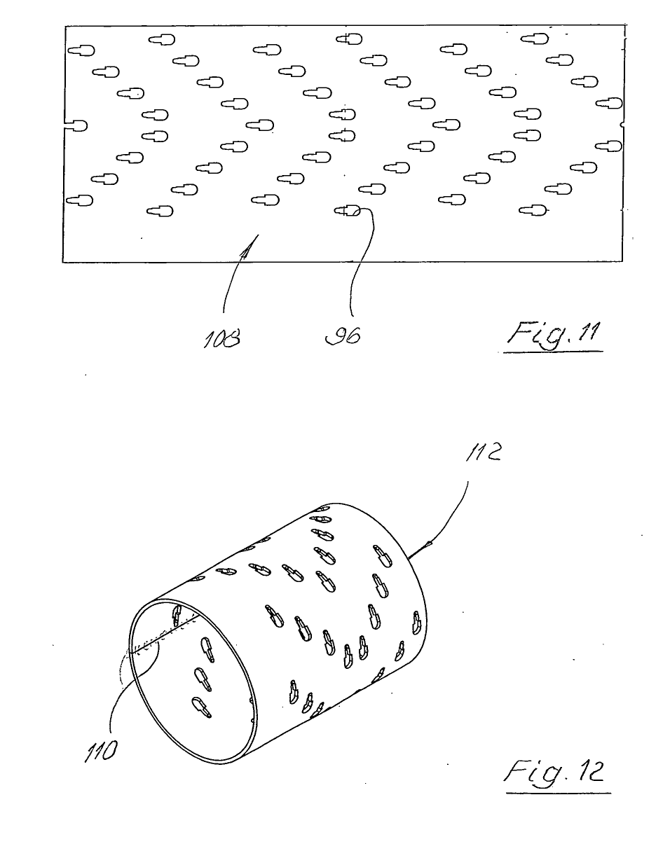

FIG. 11 shows a rectangular blank which is manufactured by being cut out from a thick metal sheet. A thick metal sheet here refers to a metal sheet whereof the thickness is between 5 mm and 40 mm, preferably approximately 10-30 mm, particularly preferably approximately 20 mm.

Incorporated in the blank 108, are through-openings 96 as have already been mentioned with reference to the exemplary embodiment described above. The through-openings 96 are generated using an NC cutting machine, which can have a laser cutting and welding head, an autogenous cutting and welding head or another cutting and welding head or another cutting head, e.g. a milling head.

As can be seen in FIG. 11, a pattern of through-openings 96 is provided over the blank 108, which pattern can be characterised by a successive V-shaped lines on which the through-openings are arranged, the point of the V being located in each case at the longitudinal centre line of the blank 108.

The individual through-openings 96 thus form arrow-shaped sets.

From the blank 1088 shown in FIG. 11, it is possible to achieve a sleeve (as shown in FIG. 12) in that the blank is bent into a cylindrical form on a rolling and bending machine.

After the blank 108 has been bent so that its short edges abut flush and flat against one another, a weld seam 110 is generated along the joint. Thus, the bent blank 108 then forms a sleeve-type circumferential wall 112 which is closed in the circumferential direction.

Bending thick metal sheets, particularly when including through-openings, in such a way that a precise cylindrical outer face of the circumferential wall 112 is already produced after the bending procedure is only possible with a high degree of complexity.

It is therefore proposed here that the blank 108 is only bent into a substantially cylindrical geometry and welded along the joint.

End parts with stub shafts are then fixedly mounted at the open end faces of the substantially cylindrical circumferential wall (denoted by 112), and subsequent mounting on the frame of the comminution machine is carried out at these stub shafts.

The rotor core which is produced in this way is then clamped in a turning machine and the outer face of the circumferential wall 112 is then skimmed and possibly still trued, thus producing a precise form which is concentric with the axis of the seated stub shafts.

The blade carriers and the blades are then inserted in the rotor core manufactured in the manner described above.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1. A comminution device comprising:
a rotor which carries blade bodies;
a counter-blade arrangement which is fixed to a frame and cooperates with the blade bodies of the rotor;
a sieve by way of which the rotor is separated from a collecting chamber for comminuted material pieces; and,
a drive motor which acts on the rotor, wherein
the rotor is hollow and is provided with a plurality of through-openings in a circumferential wall and wherein at least one end portion of the rotor has a discharge opening.

2. The comminution machine of claim 1, wherein a thickness of the circumferential wall is smaller than a depth of pockets which are provided in the circumferential wall and serve to receive blade carriers.

3. The comminution machine of claim 1, wherein at least some of the through-openings are located on trajectories which connect successive blade bodies in a circumferential direction.

4. The comminution machine of claim 3, wherein at least some of the through-openings which are located on trajectories which connect successive blade bodies in the circumferential direction, are located in front of one of the blade bodies as seen in a direction of rotation.

5. The comminution machine of claim 4, wherein a wall of the through-openings is adjacent to one of the blade bodies represents a substantially smooth continuation of a blade-body end face.

6. The comminution machine of claim 1, wherein at least some of the through-openings are arranged axially offset from paths of the blade bodies.

7. The comminution machine of claim 1, wherein a conveying coil is arranged inside the rotor body.

8. The comminution machine of claim 7, wherein the conveying coil is seated on an inside face of the rotor body.

9. The comminution machine of claim 7, wherein the conveying coil is a component which is separate from the rotor body and is seated on a driven shaft.

10. The comminution machine of claim 1, wherein the rotor has end faces, and at least one of the end faces is open.

11. The comminution machine of claim 10, wherein the rotor is mounted at its open end face by way of an outer bearing face of the rotor body.

12. The comminution machine of claim 1, wherein the rotor has at least one axial end portion in which at least one discharge opening is provided in its circumferential wall.

13. The comminution machine of claim 12, wherein the at least one axial end portion of the rotor which has at least one discharge openings is separated from a supply chamber for material to be comminuted by means of a respective dividing wall.

14. The comminution machine of claim 1, wherein the rotor body has ribs which extend in a circumferential direction and a geometry of which corresponds substantially to a clear contour of the faces over which edges of the blade bodies sweep during rotation.

15. The comminution machine of claim 1, wherein a cross-section of the through-openings corresponds substantially to a cross-section of holes in the sieve separating the rotor from the collecting chamber.

16. A process for manufacturing a hollow rotor having a plurality of through-openings in a circumferential wall for use in a comminution machine, comprising the following process steps:
manufacturing a planar blank from thick sheet metal;
bending the blank into a substantially cylindrical form in such a way that two mutually opposing edges of the blank abut against one another to form a join line; and,
connecting the blank along the join line, as a result of which a substantially cylindrical circumferential wall.

17. The process of claim 16, further comprising the step of: generating through-openings in the planar blank.

18. The process of claim 16, further comprising the step of: skimming the substantially cylindrical circumferential wall in such a way that an outer face of the circumferential wall is precisely cylindrical.

19. The process of claim 16, wherein the circumferential wall is balanced.
